(19) United States
(12) Patent Application Publication
(10) Pub. No.: US 2011/0307008 A1
(43) Pub. Date: Dec. 15, 2011

(54) SYSTEM AND METHOD FOR REINFORCING NON-USE OF A PACIFIER

(76) Inventor: PAUL ERENFELD, PORTLAND, OR (US)

(21) Appl. No.: 12/813,509

(22) Filed: Jun. 11, 2010

(51) Int. Cl. A61J 17/00

(52) U.S. Cl. 606/236

(57) ABSTRACT

A system of pacifiers adapted for reinforcing weaning of a child from pacifier use and comprising a plurality of pacifiers, each pacifier having successively appropriately smaller sized baglet portions, each pacifier having substantially identical appearing and feeling handle portions and substantially identical appearing and feeling mouth guard portions for reinforcing comfort of the child during weaning, each pacifier alternatively further comprising associated indicia for corresponding with the stages or chapters of a predetermined story, illusion or other method of weaning a child from pacifier use wherein the person employing a method of the patent either secretly, or as part of an overall calming context, introduces substitute smaller baglet pacifiers as previous larger baglet pacifiers, successively in order largest to smallest, along with the predetermined emotionally reassuring story as to disposition of previous pacifiers as necessary to calm the child.

### BACKGROUND OF THE INVENTION

The present invention relates in general to systems and methods for weaning infants off of their pacifiers and in particular to a set of pacifying devices specifically designed and manufactured for use with a method of successfully reinforcing termination of use of the pacifier at an appropriate time.

The discretionary decisions whether, when and how to take a baby pacifier away has caused parents angst. The reasons for and desirability of weaning at the appropriate time are understood. One reason given for weaning is to allow proper tooth alignment. Some pediatric dentists assert that excessive pacifier use may cause misalignment of teeth. Another reason given for weaning is the avoidance of ear infections, asserted by some pediatricians to be caused by excessive pacifier use. Still another reason is asserted by some child psychologists that too much pacifier use may interfere with proper speech, language and social development, since the pacifier that is constantly in the child's mouth interferes with otherwise normal use of the mouth and lips. Finally, of course, the mere need to keep a supply of pacifiers, to keep them clean and free of bacteria, and to cope with a child's developed psychological sensitivities around pacifier use and the need to have a particular pacifier, present a reason to desire weaning.

There are those that have advocated “going cold turkey” with termination of pacifier use. In other words, this method of pacifier use termination is accomplished all at once, whether suddenly, by surprise or after preparation and advance coaching to the child. While the cold turkey method may avoid some of the difficulty and need for consistency with a more time-extended system and method of weaning from pacifier use, others claim this method is unduly emotionally and psychologically painful for the child to deal with, not to mention the psychological pain that must be endured by the parent of such a child as he or she must cope with the upset emotional state of the child experiencing the process.

Responsive to the “cold-turkey” method, one prior art method of reinforcing non-use of a pacifier has involved means of making a pacifier physically less desirable to a baby, such as by poking holes, slicing or cutting off in the nipple, or baglet, of the pacifier, combined with what may be euphemistically referred to as storytelling, for example fibbing to the child by acting as if the parent does not know that the pacifier is different or made intentionally defective. With this method and home-made system of weaning, the intent is to slightly alter in an aftermarket way the integrity of the pacifier so that it isn't as satisfying to suck.

This method of reinforcing non-use of a pacifier has fueled a debate on what is best for the child, it being the case that such actions of altering the integrity of the pacifier may possibly lead to instances of ingestion by the baby of portions of the pacifier that may be chewed or pulled off, or instances of infection or disease resulting from increased likelihood of multiplication of bacteria in crevices of the altered device that are not easily reached for cleaning.

Responsive to the attendant problems of such homemade remedies addressing the issue of weaning, other prior art systems of reinforcing non-use of a pacifier, or weaning a baby off a pacifier, have involved an aftermarket solution derived from placing undesirable tasting fluids on a child's fingers to prevent thumb sucking. In the case of the pacifier, however, this aftermarket prior art method has involved the intentional introduction of elements into or onto the pacifier that, while not harmful to the physical health of the child, nevertheless have made the pacifier less desirable to the infant. Thus, such devices have involved storing an undesirable tasting liquid within the baglet of the pacifier, allowing for gradual leakage of the undesirable tasting liquid, or coating of the pacifier with the less than desirable tasting compound.

While such systems may ultimately be effective to reinforce non-use of the pacifier, one must ask at what cost to the baby? Thus, while the compounds used themselves may even be biochemically harmless to the child, again one must ask whether they would want to intentionally introduce a less than desirable taste into their child's mouth with its attendant psychological ramifications? This and similar practices have fueled a debate on what is best for children, it being the case that the more reasoned opinions have concluded that a least intrusive means of weaning is to be preferred.

Accordingly, the need for an effective, integrated system and method of safely weaning babies from their pacifiers is needed. And while most parents accept the need for story telling in connection with the pacifier weaning process, it is commonly preferred that the story at least involve a happy ending that is reinforced with a system for slightly diminishing pleasure and satisfaction derived from a pacifier by the child gradually over time.

### SUMMARY OF THE INVENTION

In accordance with a first aspect and embodiment of the present invention, there is provided a system or series of pacifiers adapted for reinforcing weaning a child from pacifier use, the system comprising a plurality of pacifiers further comprising at least a largest pacifier, a smallest pacifier and at least one middle pacifier, each pacifier having a baglet portion, a substantially identical appearing and feeling handle, and a substantially identical appearing and feeling mouth guard for reinforcing comfort of the child in consistent appearance and feel of the pacifier, the largest pacifier comprising a baglet portion that is of a size relatively larger than the baglet portion of the at least one middle pacifier and the baglet portion of the smallest pacifier, the smallest pacifier comprising a baglet portion that is of a size relatively smaller than the baglet portion of the largest pacifier and the baglet portion of the at least one middle pacifier.

Thus, with the system of pacifiers in accordance with this first aspect of the invention, each successively smaller baglet portion of the pacifiers, down to the smallest baglet pacifier, is of a relatively smaller size as compared to the next largest pacifier baglet on up to the first, and largest, baglet size pacifier.

The system of pacifiers in accordance with this first aspect and embodiment of the invention addresses the limitations of prior art systems and methods of weaning infants and babies from pacifiers in that there is no longer a need for total and complete termination of pacifier use, as with the cold-turkey method, whether suddenly by surprise or after explanation, thus avoiding the traumatic introduction of radical change to a comforting element of a sensitive child's emotional world and thus avoiding, or at least minimizing, the child's attendant emotional upset.

Further, the system of pacifiers in accordance with this first aspect and embodiment of the invention avoids the need of prior art systems and methods of aftermarket alteration of the baglet portion of the pacifier, such as by poking or cutting holes therein to introduce physical discomfort or lack of physical satisfaction to the child. Thus, the system of pacifiers in accordance with the first aspect and embodiment of the invention helps relieve the attendant negative consequence of such prior art methods and systems wherein the baglet portion of the pacifier has earlier lost its integrity and has more easily harbored harmful bacteria in portions of the baglet that are more inaccessible to cleaning.

Similarly, this system of pacifiers in accordance with this first aspect and embodiment of the invention avoids the need of prior art systems and method of aftermarket impregnation, filling or coating of pacifiers with an unpleasant tasting liquid or compound. Thus, the present invention helps minimize the attendant trauma felt by the child that has been associated with attempting a desirable and comforting means, only to be shocked to have to experience an affirmatively unpleasant experience, such as an unpleasant taste. Accordingly, the emotional upset and psychological trauma to the child associated with such prior art methods are minimized.

In accordance with another aspect of the invention, the baglet of each pacifier in the system of pacifiers is similar in shape to the other baglets of the series, such that the baglet of each pacifier in the series of pacifiers is proportional to each other pacifier baglet, but each such baglet differs in size from each other baglet of the plurality of pacifiers and only to a degree that is sufficiently large to address an optimum weaning schedule for accomplishing weaning in a minimum amount of time but that is also sufficiently small so as to minimize likelihood of disquiet of a child during the weaning process.

The system of pacifiers in accordance with this aspect of the invention minimizes the amount of time necessary to wean a child from pacifier use while at the same time minimizing the amount of upset experienced by a child during the weaning process. Though experts suggest that weaning should take about a week, there is no concrete rule for the perfect amount of weaning time, and each child is different. Accordingly, while the shape of each successively smaller baglet portion is of proportionally similar shape, each such successively smaller baglet is nevertheless slightly smaller in size than the next previously larger baglet. Thus, preferably, the baglets are designed, as with commonly known parametric means employing proportional zoom type scaling, with each successively smaller baglet being enough smaller and so on until the last or smallest baglet pacifier is so small as to provide little satisfaction to the child.

In accordance with another aspect of the invention, there is provided for addition to the series or system of pacifiers a null or nullified pacifier comprising a handle substantially identical in appearance and feel to the handle of each of the plurality of pacifiers and a mouth guard that is substantially identical in appearance and feel to the mouth guard of each of the plurality of pacifiers, the nullified pacifier being devoid of any baglet.

The system of pacifiers in accordance with this aspect of the invention provides an ultimate alternative to a pacifier suitable for comfortable suckling by a child in that the child can still hold the handle and mouth guard for comfort sake while believing that the baglet portion of the pacifier has gone to a better place or believing that the baglet portion of the pacifier has been retired for use only after making sure that the child has grown sufficiently sturdy to handle retirement of the pacifier with a minimum of fuss.

In accordance with yet another aspect of the invention, there is provided, in addition to the system of pacifiers described above comprising the plurality of pacifiers adapted for reinforcing weaning a child from pacifier use, the system of pacifiers further alternatively comprising a nullified pacifier as described above, that at least one of the handles and the mouth guards comprises a system of indicia that reinforces emotionally reassuring storytelling or an illusion by the parent, or other attendant, to the child regarding disposition of each pacifier, either upon discovery by the child of substitution of a smaller pacifier or as part of coordinated effort to wean the child from pacifier use with storytelling or illusions.

The indicia set forth in this aspect of the invention may preferably comprise a very small number etched into the handle or mouth guard of the pacifier, for example with the pacifier having the largest baglet the number “1” or scripted “one”, the pacifier having the next smallest baglet being number “2” or scripted “two”, and so on “3”, “4”, “5”, “6”, etc., as desirable, to the last pacifier having the smallest baglet. The indicia system is preferably very small so as to be virtually unnoticeable to the baby using the pacifier.

Alternatively to a numbering system, a system of colors may be used, to correlate a particularly sized pacifier with a sequenced chart, legend or index card aiding in each next step of the story or illusion. Thus, while the indicia may serve partially to indicate the size of the pacifier baglet, the indicia on the pacifier may also then be used by the parent, or other user, to reference the next chapter, step or stage of a predetermined, emotionally reassuring story about the disposition of the previous pacifier, or as part of a guided context for the user. Such a story or context may include a story about how each previous pacifier has gone to heaven, or it may prompt the parent to reassure the child that the previous pacifier stayed as long as it needed to in order to be sure that the child was sufficiently sturdy emotionally to accept the passing of the previous pacifier into non-existence, heaven, or whatever fate the parent would like to adopt as an emotionally reassuring story for the child.

Of course, this aspect of the invention helps minimize the traumatic effect on the child associated with losing a comforting device by reinforcing and even encouraging positive associations, storytelling and illusions, as deemed appropriate by a given user and in a given situation. Since each child is of different ability to understand, given the age and mental capacity at which weaning is attempted, the minimal numbering system of indicia will allow the grown-up to adapt the story to the understanding of the child.

In accordance with another aspect of the invention, there is provided a method for a person to wean a child from pacifier use comprising the following steps: obtaining a plurality of pacifiers having baglet portions, identical handles and identical mouth guards, each of the baglet portion of the plurality of pacifiers being different in size from the baglet portion of the others of the plurality of pacifiers; introducing as a previous pacifier during a first period of time one of the pacifiers having a largest sized baglet portion to the child; continuing introduction to the child during at least one intermediate period of time as the previous pacifier another of the plurality of pacifiers secretly known to the person as a substitute intermediate pacifier and having a next smaller size baglet portion compared with the previous pacifier; introducing to the child as a last pacifier during a final period as the previous pacifier a final of the plurality of pacifiers secretly known to the person as a substitute final pacifier and having a smallest size baglet portion compared with the previous pacifier and each intermediate pacifier.

Further, the method of the invention in accordance with this aspect of the invention may alternatively comprise story telling as prompted by associated indicia on at least one of the handles and the mouth guards of the plurality of pacifiers. The method of this aspect of the invention provides steps for addressing the difficulty of weaning a child off a pacifier, without the attendant shortcomings of prior art systems and methods.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF THE DRAWINGS

FIG. 1a-f shows a front plan view of a system of pacifiers in accordance with an embodiment of the invention;

FIG. 2a shows a front plan view of a null pacifier adapted for addition to the system of pacifiers shown in FIG. 1;

FIG. 2b shows a front plan view of a null pacifier adapted for addition to the system of pacifiers shown in FIG. 3;

FIG. 3a-f shows a front plan view of a system of pacifiers in accordance with another embodiment of the invention;

FIG. 4 shows a plan view of a system of pacifiers in accordance with an embodiment of the invention in packaging;

FIG. 5 shows a plan view of a system of pacifiers in packaging and having indicia thereon in accordance with an embodiment of the invention and with one of the indicia being shown enlarged for clarity; and

FIG. 6 shows a plan view of an index reference card for correlating each pacifier of a set of pacifiers with a stage or chapter of a plan for weaning.

### DETAILED DESCRIPTION

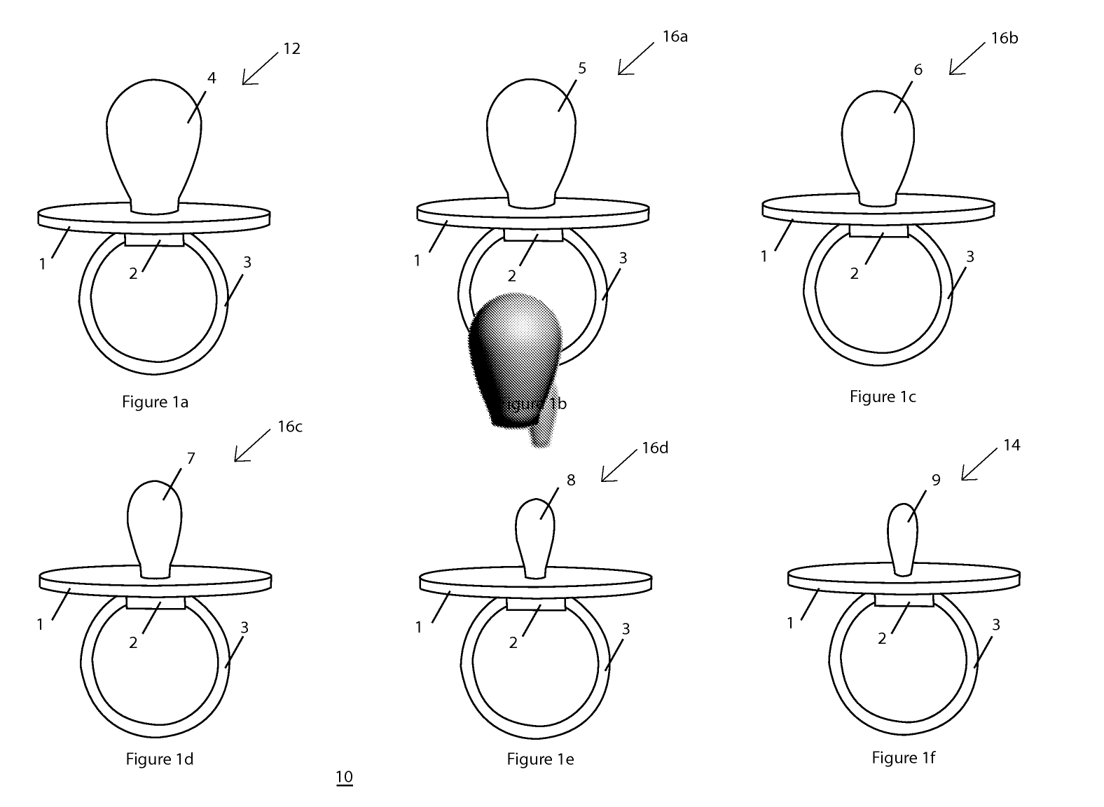

Referring to FIG. 1 a-f there is provided a first embodiment of the present invention, comprising a system or series 10 of pacifiers adapted for reinforcing weaning a child from pacifier use, the system comprising a plurality of pacifiers 10 comprising at least a largest pacifier 12, a smallest pacifier 14 and at least one middle pacifier 16 a-d. In a preferred embodiment of the invention, there are other intermediate pacifiers 16 b-d as shown. Also, in a preferred embodiment of the invention, as shown in FIG. 1 a-f, each pacifier has a nipple or baglet portion 4, 5, 6, 7, 8, 9, a mouth guard, shield or bond ring portion 1, and a circular handle or holding structure 3 that is preferably substantially identical appearing and feeling for each pacifier in the system. Attached or integral with a distal surface of each mouth guard 1 there is shown a handle attachment means 2, such as a molded a handle retaining member 2 having a aperture defined therein and adapted for receiving and pivotably retaining the handle 3.

It will be appreciated by those of ordinary skill in the art that any of many known handle, mouth guard, and handle retaining members in the art may be substituted for those shown in FIG. 1 a-f in their most generic and simplest form for purposes of illustration and more importantly for purposes of pointing out that such substitution may be made without departing from the true scope and spirit of the invention as set forth in the attached claims. In other words, a primary consideration in making the system of the first aspect of the invention is uniformity among all pacifiers of the system or series 10 of the handle 3, mouth guard 1 and handle retaining member 2 portions of the series of pacifiers, each handle 3 being substantially identical appearing and feeling to each other handle 3 of the series, and each mouth guard 1 being substantially identical appearing and feeling to each other mouth guard 1 of the series, to reinforce sameness and secrecy as to the whereabouts of previous pacifiers and/or story telling context or illusion regarding the same to enable reinforcement of comfort of the child during the process of weaning. Whether this is accomplished with a square handle, a differently shaped mouth guard, or a generic or other version of these, is immaterial to the applicability of the claims appended hereto.

Further, it will be appreciated by those of ordinary skill in the art that any of many known baglet designs may be substituted for the baglets shown without departing from the true scope and spirit of the invention, a primary consideration being substantial uniformity of the baglet in terms of smoothness, texture, color and even to a degree shape, except only that the size of the baglet from one pacifier to the next in the series is decreased in size. Thus, it will be noted from looking at FIG. 1 a-f, that the largest pacifier 12 comprises a baglet portion 4 that is of a size relatively larger than the baglet portion of the at least one middle pacifier 16a and the baglet portion of the smallest pacifier 14, the smallest pacifier comprising a baglet portion 9 that is of a size relatively smaller than the baglet portion 4 of the largest pacifier 12 and the baglet portion of the at least one middle pacifier 16 a-d. As shown the middle pacifiers 16 a, b, c, d comprise baglets 5, 6, 7, 8 respectively. Thus, as may be seen from FIG. 1 a-f, baglet 9 is smaller than baglet 8, baglet 8 is smaller than baglet 7, baglet 7 is smaller than baglet 6, baglet 6 is smaller than baglet 5, and baglet 5 is smaller than baglet 4.

Thus, with the system of pacifiers 10 in accordance with this first aspect of the invention, each successively smaller baglet portion of the pacifiers, down to the smallest baglet pacifier 14, is of a relatively smaller size as compared to the next largest pacifier baglet on up to the first, and largest, baglet size pacifier. In other words, the system of pacifiers 10, comprises a plurality of pacifiers 12, 16 a-d, and 14, wherein the size of each baglet of each pacifier differs proportionally in size from the other baglets of the plurality of pacifiers and only to a minimal degree but that is sufficiently large to address an optimum weaning schedule for accomplishing weaning in a minimum amount of time and to a degree that is also sufficiently small so as to minimize likelihood and/or magnitude of disquiet or upset of a child during the weaning process.

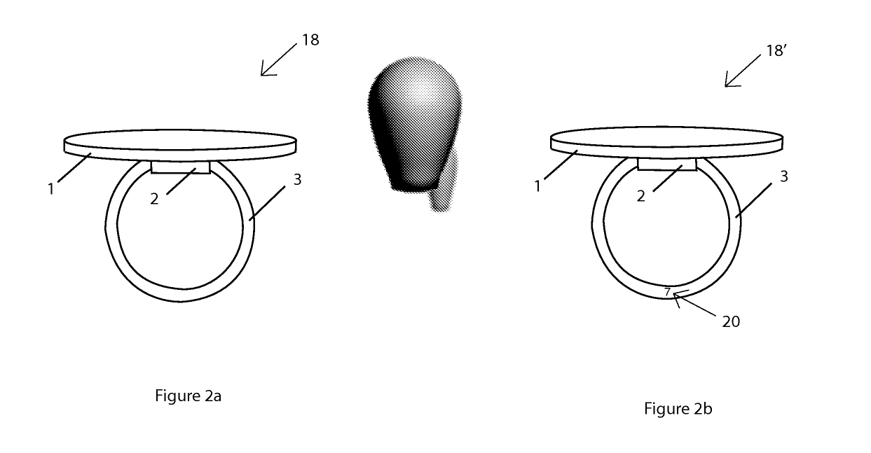

As shown in FIG. 2, in accordance with an alternate embodiment of the invention, there is shown a nullified or null pacifier 18. Null pacifier 18 is advantageously included with the series of pacifiers 10. Null pacifier 18 comprises a handle 3 substantially identical in appearance and feel to each other handle 3 of each of the plurality of pacifiers 10 and a mouth guard 1 substantially identical in appearance and feel to the mouth guard 1 of each of the mouth guards 1 of the plurality of pacifiers 10 for reinforcing comfort of the child being weaned, the only difference between the null pacifier 18 and the other pacifiers of the plurality of pacifiers 10 being that null pacifier 18 is devoid of any baglet.

The system of pacifiers 10 (including null pacifier 18) in accordance with this aspect of the invention provides an ultimate alternative to a pacifier suitable for comfortable suckling by a child in that the child can still hold the handle 3 and attached mouth guard 1 for comfort sake while believing that the baglet portion of the pacifier has gone to a better place or believing that the baglet portion of the pacifier has been retired for use only after making sure that the child has grown sufficiently sturdy to handle retirement of the pacifier with a minimum of fuss.

This system of pacifiers 10 reinforces positive storytelling and/or illusion regarding the disposition of previous pacifiers, since it cues the user to think and teach in terms of gradual displacement of the comforting device or mechanism with feelings of calm, safety and emotional well-being.

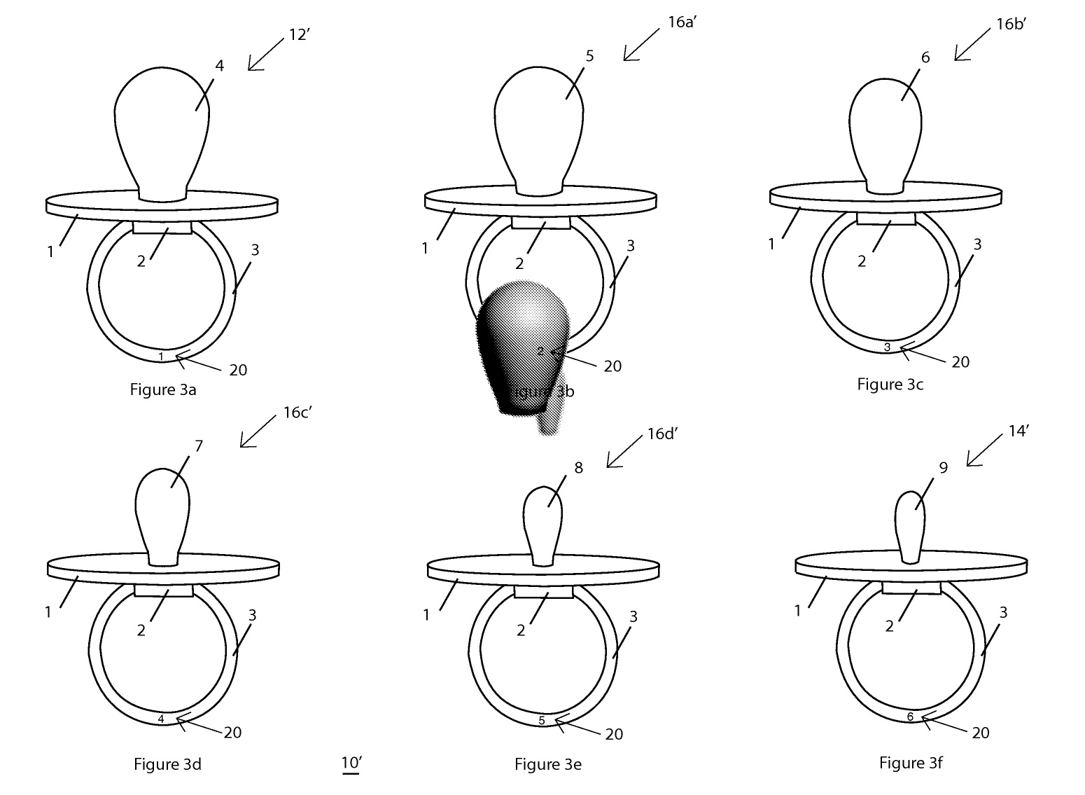

As shown in FIG. 3 a-f, an alternative embodiment of a series 10′ of a plurality of pacifiers 12′, 16 a′-d′, and 14′ in accordance with another aspect of the invention is shown with each pacifier of the series comprising handles 3, mouth guards 1, handle retaining members 2, and decreasing sized baglets 4, 5, 6, 7, 8, 9 of the same design and performing the same function as described above in accordance with the first embodiment of the invention. As shown the middle pacifiers 16 a′, b′, c′, d′ comprise baglets 5, 6, 7, 8 respectively. Thus, as may be seen from FIG. 3 a-f, baglet 9 is smaller than baglet 8, baglet 8 is smaller than baglet 7, baglet 7 is smaller than baglet 6, baglet 6 is smaller than baglet 5, and baglet 5 is smaller than baglet 4.

However, in accordance with this second embodiment of the invention, handles 3, mouth guards 1, handle retaining members 2 and/or other portions of a pacifier not shown, further comprise a system of indicia 20 that reinforces emotionally reassuring story telling or illusion to the child regarding disposition of each previous pacifier. This reinforcement may be facilitated either upon discovery by the child of substitution of a smaller pacifier or as part of coordinated effort to wean the child from pacifier use with guided story telling or illusions.

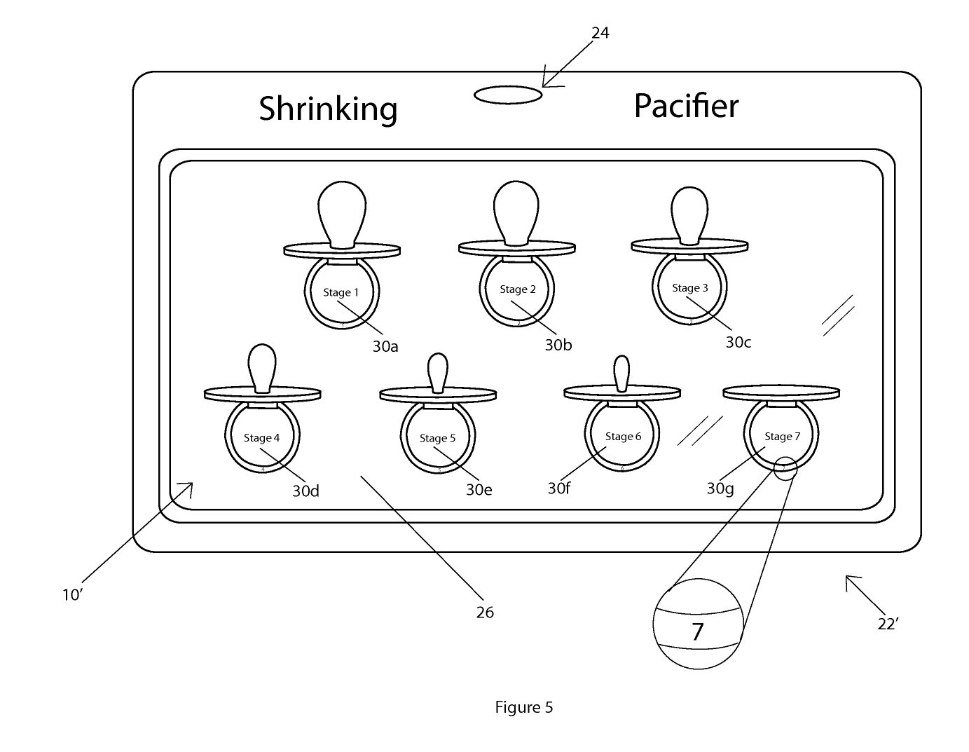

As shown in FIG. 3 a-f, the indicia set forth in this aspect of the invention may preferably comprise a very small number etched into the handle or mouth guard of the pacifier, for example with the pacifier having the largest baglet the number “1” or scripted “one”, the pacifier having the next smallest baglet being number “2” or scripted “two”, and so on “3” or “three”, “4” or “four”, “5” or “five”, “6” or “six”, etc., as desirable, to the smallest pacifier having the smallest baglet (or for example the null pacifier designated “7” as shown in FIG. 2b or “seven”). Preferably, the indicia 20 on pacifiers 10′ may be used to correlate a particularly sized and referenced pacifier with a sequenced chart 30 a-g (shown in FIG. 5) that may in turn be used to reference a stage of a predetermined story or illusion that reinforces successful weaning from pacifier use.

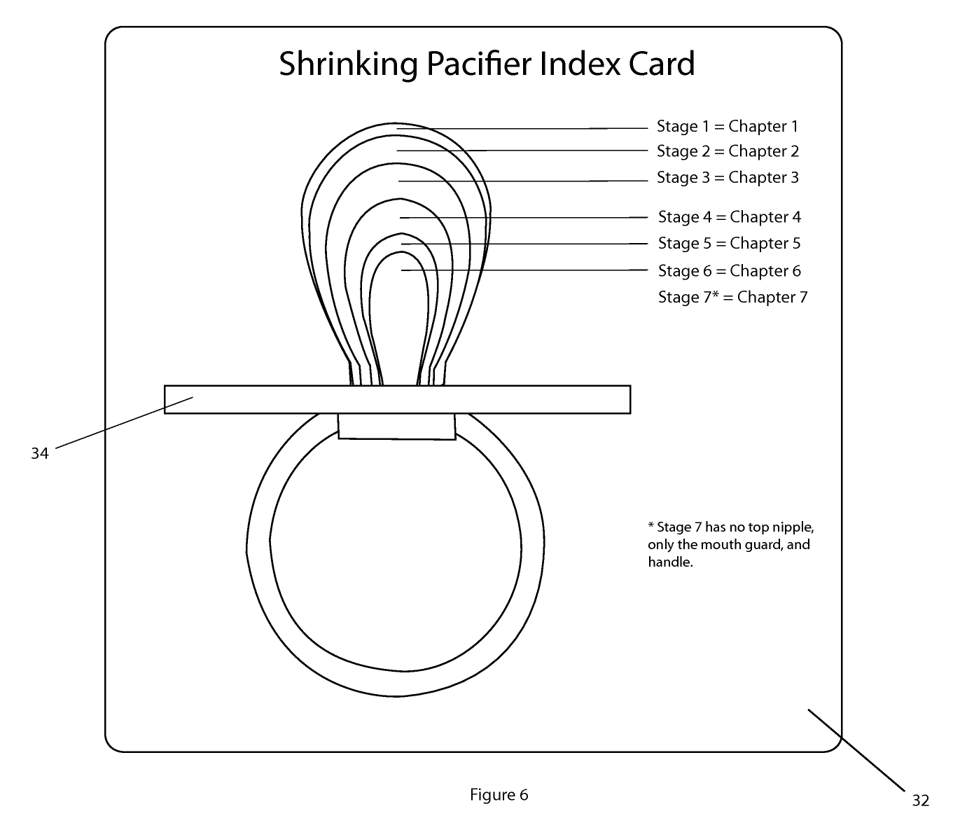

Alternatively, the pacifiers 10 or 10′ may be compared to a chart, reference card or index card 32 as shown in FIG. 6, which in turn, depending upon the size of pacifier considered, references a specific stage or chapter of a predetermined story or illusion that reinforces successful weaning. Reference card 32 shows an outline of each of the pacifiers 10, including null pacifier 18, so that the card is adapted for use in comparing a particular pacifier with the card to determine which pacifier is being used.

Preferably, card 32 includes a slot 34 in which a particular pacifier mouth guard partially fits to assist with positioning the baglet portion of the particular pacifier being indexed as close as possible to the outline on the card for comparison purposes. Such a card 32 may be part of the packaging, a separate reference sheet or electronic media such as a computer CD, DVD, or Internet website for transmitting successful weaning stories or illusions. In this way, the user is aided in determining which pacifier, of a series of pacifiers, he or she may have in hand, since it may be difficult to tell one pacifier from another, given a desirable minimal degree of difference from one pacifier to the next. Also, the reference card 32 assists the user in correlating a particular pacifier with the stage or chapter of a story or illusion adapted for calming the child and reinforcing weaning from pacifier use. Such a card would not be necessary in the case of pacifiers 10′ including indicia numerals.

In this way the user is also encouraged to plan ahead for a predetermined course of storytelling or illusion to reassure the child during weaning. Alternatively, a color coded scheme may be utilized to reference each pacifier in the system 10′, with a small swatch of color on a part of the pacifier, or a portion of the pacifier being of a particular color, each different sized pacifier bearing a different color and corresponding to a different phase, stage or chapter of a reinforcing story or illusion referenced in the packaging or on a reference index card. The particular color of the swatch or pacifier part may be integrated into the story or illusion for reassuring the child.

Thus, while the indicia 20 may serve partially to indicate the size of the pacifier baglet 4-9, the indicia on the pacifier may also then be used by the parent, or other user, to reference the next chapter, step or stage of a predetermined, emotionally reassuring story or illusion. In this way, the parent, or other user, is encouraged in planning ahead to develop or obtain such an emotionally reassuring story about the disposition of the previous pacifier, or as part of a guided context for the user. Such a story or context may include a story about how each previous pacifier has gone to heaven, or it may prompt the parent to reassure the child that the previous pacifier stayed as long as it needed to in order to be sure that the child was sufficiently sturdy emotionally to accept the passing of the previous pacifier into non-existence, heaven, or whatever fate the parent would like to adopt as an emotionally reassuring story for the child.

Of course, this aspect of the invention helps minimize the traumatic effect on the child associated with losing a comforting device by reinforcing and even encouraging positive associations, storytelling and illusions, as deemed appropriate by a given user and in a given situation. Since each child is of different ability to understand, given the age and mental capacity at which weaning is attempted, the minimal numbering system of indicia will allow the grown-up to adapt the story to the understanding of the child.

As with the system 10 of pacifiers in accordance with the first embodiment of the invention, the system 10′ of pacifiers in accordance with this second embodiment of the invention employing indicia on the handles 3, mouth guard 1, handle retaining member 2, and/or other portion of the pacifier, each baglet of each pacifier differs in size from the other baglets of the plurality of pacifiers only to a degree that is sufficiently large to address an optimum weaning schedule for accomplishing weaning in a minimum amount of time and to a degree that is also sufficiently small so as to minimize likelihood and/or magnitude of disquiet of a child during the weaning process.

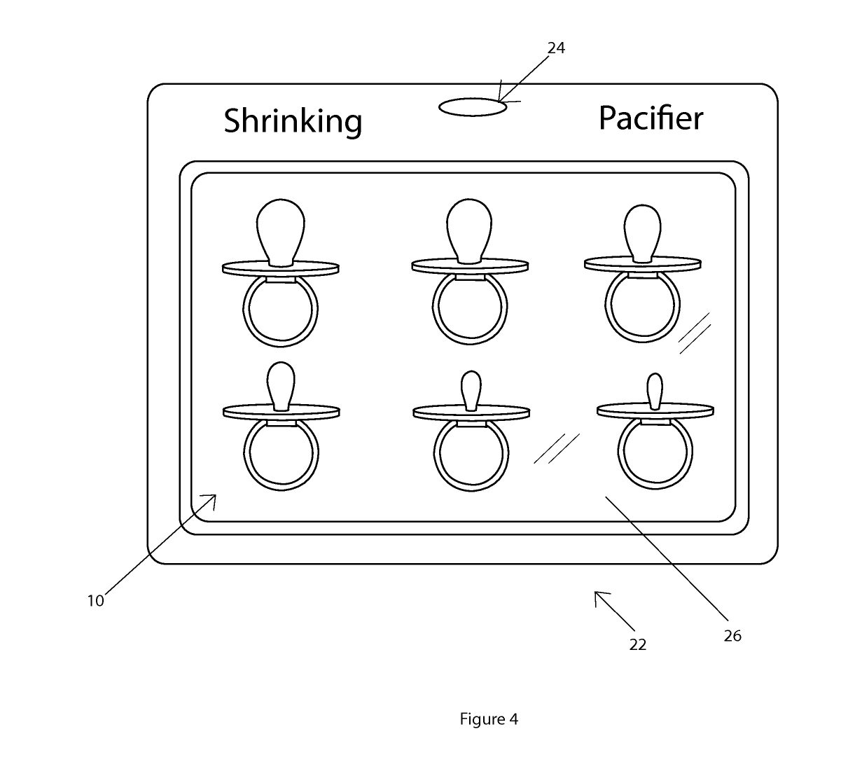

As shown in FIGS. 4 and 5, there is provided a system of pacifiers 10, 10′ housed and retained in packaging 22, 22′ preferably designed with an opening 24 for hanging display at a store. Packaging 22, 22′ preferably includes a clear plastic surface 26 as is standard in the art and that is suitable to allow viewing of the series of pacifiers 10, 10′ to assist with visual instruction of the purchaser regarding proper use of the system 10, 10′ to reinforce weaning of a child from pacifier use.

As used in this patent, the term “last pacifier”, depending upon the context, may refer to the smallest pacifier with a baglet, or it also may refer to the final pacifier used in a process of weaning (even though such may be an intermediate pacifier), and thus it is understood that these terms may or may not refer to the same pacifier without limiting the claims from their intended scope. Similarly, the term “null pacifier” refers loosely to a pacifier less a baglet, and thus such a null pacifier may also be referred to as a “last pacifier” or a “smallest pacifier” without limiting the claims from their intended scope.

Of course, it will be obvious to those of ordinary skill in the art that packaging 22, 22′ may contain therein instructions for appropriate use of the system 10, 10′ to reinforce positive association and calmness of a child during the weaning process.

While preferred embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1) A system of pacifiers adapted for reinforcing weaning a child from pacifier use, said system comprising a plurality of pacifiers further comprising:
a largest pacifier;
a smallest pacifier; and
at least one middle pacifier, each said pacifier having a baglet portion, a substantially identical appearing and feeling handle, and a substantially identical appearing and feeling mouth guard for reinforcing comfort of the child in appearance and feel of the pacifier, said largest pacifier comprising a baglet portion that is of a size relatively larger than said baglet portion of said at least one middle pacifier and said baglet portion of said smallest pacifier, said smallest pacifier comprising a baglet portion that is of a size relatively smaller than said baglet portion of said largest pacifier and said baglet portion of said at least one middle pacifier.

2) The system of pacifiers of claim 1, wherein the size of each said baglet of each said pacifier differs proportionally in size from the other baglets of said plurality of pacifiers to a degree that is sufficiently large to address an optimum weaning schedule for accomplishing weaning in a minimum amount of time and also to a degree that is sufficiently small so as to minimize likelihood of disquiet of a child during a weaning process.

3) The system of pacifiers of claim 1, wherein said smallest pacifier comprises a nullified pacifier comprising a handle substantially identical in appearance and feel to said handle of each of said plurality of pacifiers and a mouth guard substantially identical in appearance and feel to said mouth guard of each of said plurality of pacifiers, said nullified pacifier being devoid of any baglet.

4) The system of pacifiers of claim 2, said plurality of pacifiers further comprising a system of indicia that reinforces emotionally reassuring storytelling to the child regarding disposition of each said pacifier.

5) The system of pacifiers of claim 4, wherein said system further comprises a predetermined story adapted for explaining the disposition of each said pacifier during a process for weaning, and wherein said indicia comprises a number on each said pacifier that references a corresponding stage of said predetermined story.

6) The system of pacifiers of claim 2, further comprising at least one reference comprising a plurality of reference outlines, one outline corresponding in size to each said pacifier of said system of pacifiers, each said outline further corresponding to a stage in a process for weaning a child from pacifier use, said reference being adapted for use to correlate a particular pacifier with a particular stage in said process.

7) A system of pacifiers adapted for reinforcing weaning a child from pacifier use, said system comprising a plurality of pacifiers further comprising:
a largest pacifier;
a smallest pacifier;
at least one middle pacifier, each said pacifier having a baglet portion, a substantially identical feeling and shaped handle, and a substantially identical feeling and shaped mouth guard for reinforcing comfort of the child in appearance and feel of the pacifier, said largest pacifier comprising a baglet portion that is of a size relatively larger than said baglet portion of said at least one middle pacifier and said baglet portion of said smallest pacifier, said smallest pacifier comprising a baglet portion that is of a size relatively smaller than said baglet portion of said largest pacifier and said baglet portion of said at least one middle pacifier;
a nullified pacifier comprising a substantially identical feeling and shaped handle to said other handles of said system of pacifiers, said nullified pacifier further comprising a substantially identical feeling and shaped mouth guard to said other mouth guards of said system of pacifiers; and
a system of indicia on at least one of said pacifiers that reinforces emotionally reassuring storytelling to the child regarding disposition of each said pacifier.

8) The system of pacifiers of claim 7, wherein said system of indicia is carried on at least one of said handles and said mouth guards.

9) The system of pacifiers of claim 7, wherein the size of each said baglet of each said pacifier differs in size from each other baglet of said plurality of pacifiers only to a degree that is sufficiently large to address an optimum weaning schedule for accomplishing weaning in a minimum amount of time and to a degree that is also sufficiently small so as to minimize likelihood of upset of a child during a weaning process.

10) A system of pacifiers adapted for reinforcing weaning a child from pacifier use, said system comprising a plurality of pacifiers further comprising:
a largest pacifier;
a smallest pacifier;
at least one middle pacifier, each said pacifier having a baglet portion, a substantially identical appearing and feeling handle, and a substantially identical appearing and feeling mouth guard for reinforcing comfort of the child in appearance and feel of the pacifier, said largest pacifier comprising a baglet portion that is of a size relatively larger than said baglet portion of said at least one middle pacifier and said baglet portion of said smallest pacifier, said smallest pacifier comprising a baglet portion that is of a size relatively smaller than said baglet portion of said largest pacifier and said baglet portion of said at least one middle pacifier; and
packaging for holding and presenting said plurality of pacifiers as a series of pacifiers adapted for use regarding the purpose of reinforcing weaning of a child from pacifier use.

11) The system of pacifiers of claim 10, said plurality of pacifiers further comprising a system of indicia that reinforces emotionally reassuring storytelling to the child regarding disposition of each said pacifier.

12) The system of pacifiers of claim 11, wherein said system further comprises a predetermined story adapted for explaining the disposition of each said pacifier during a process for weaning, and wherein said indicia comprises a number on each said pacifier that references a corresponding stage of said predetermined story.

13) The system of pacifiers of claim 10, further comprising at least one reference comprising a plurality of reference outlines, one outline corresponding in size to each said pacifier of said system of pacifiers, each said outline further corresponding to a stage in a process for weaning a child from pacifier use, said reference being adapted for use to correlate a particular pacifier with a particular stage in said process.

14) The system of pacifiers of claim 10, wherein said system further comprises a predetermined story adapted for explaining the disposition of each said pacifier during a process for weaning, and wherein said packaging comprises indicia for correlating a pacifier of said system of pacifiers with a corresponding stage of said predetermined story.

15) The system of pacifiers of claim 10, wherein said smallest pacifier comprises a nullified pacifier comprising a handle substantially identical in appearance and feel to said handle of each of said plurality of pacifiers and a mouth guard substantially identical in appearance and feel to said mouth guard of each of said plurality of pacifiers, said nullified pacifier being devoid of any baglet.

16) A method for a person to wean a child from pacifier use comprising the steps of:
Obtaining a plurality of pacifiers having baglet portions, identical handles and identical mouth guards, each of said baglet portions of said plurality of pacifiers being different in size from the baglet portions of the others of said plurality of pacifiers;
Introducing as a previous pacifier during a first period of time one of said pacifiers having a largest sized baglet portion to the child;
Continuing introduction to the child during at least one intermediate period of time as said previous pacifier another of said plurality of pacifiers secretly known to the person as a substitute intermediate pacifier and having a next smaller size baglet portion compared with said previous pacifier;
Introducing to the child as a last pacifier during a final period as said previous pacifier a final of said plurality of pacifiers secretly known to the person as a substitute final pacifier having one of a baglet having a smallest size baglet portion compared with each said previous pacifier and each said intermediate pacifier and no baglet at all.

17) The method of claim 16, wherein each pacifier further comprises indicia supportive of an emotionally reassuring story as to the disposition of said previous pacifier and each said intermediate pacifier should the child question disposition of any said pacifier.
